(19) United States
(12) Patent Application Publication
(10) Pub. No.: US 2007/0012748 A1
(43) Pub. Date: Jan. 18, 2007

(54) Method for manufacturing multi-component structural members

(76) Inventors: Edward J. McCrink, Escondido, CA (US); Danny Codd, Escondido, CA (US)

Correspondence Address: DRUMMOND & DUCKWORTH, Suite 500, 4590 MacArthur Blvd., Newport Beach, CA, 92660, US

(21) Appl. No.: 11/526,258

(22) Filed: Sep. 22, 2006

Related U.S. Application Data
(63) Continuation-in-part of application No. 11/143,848, filed on Jun. 1, 2005.
Application No. 11/143,848 is a continuation-in-part of application No. 10/519,910.
(60) Provisional application No. 60/301,970, filed on Jun. 29, 2001.

(51) Int. Cl. A47J 36/02

(52) U.S. Cl. 228/101

(57) ABSTRACT

A method for fabricating multi-component structural members includes brazing a first component of air-hardenable martensitic stainless steel to a second component made of ferrous, stainless or nickel alloy steels. The martensitic stainless steel first component is preferably type 410, 420 or 440 and formed while in the annealed condition. The martensitic stainless steel component is simultaneously brazed and hardened to the second structural component by heating both components to between 950° C. and 1100° C. while depositing a brazing compound between the structural components to form a joint. The structural members are then cooled at a rate of 25° C. per minute or greater so as to transform the air-hardenable martensitic stainless steel to a predominantly martensitic state.

### RELATED APPLICATIONS

This application is a continuation-in-part application of pending U.S. application Ser. No. 11/143,848 filed on Jun. 1, 2005, which in turn, is a continuation-in-part application of pending U.S. application Ser. No. 10/519,910 filed on Dec. 30, 2004, which is in turn, a National Phase application of International Application Serial No. PCT/US02/20888 filed on Jul. 1, 2002, which in turn, claims priority to U.S. Provisional Application No. 60/301,970 filed on Jun. 29, 2001.

### BACKGROUND OF THE INVENTION

The present invention relates to structural members for a wide variety of load bearing applications including planes, trains, boats, bridges, building reinforcements, and automobiles. More particularly, the present invention relates to automotive structural members for automobiles and trucks. Still even more particularly, the present invention relates to a method of manufacturing original equipment and after-market automotive structural members such as vehicle pillars, sub-frames, cross beams, frame rails, frame brackets, roof rails, seat frames, door beams, bumper beams, control arms, wheels, instrument panel reinforcements, running boards, roll-bars, tow hooks, bumper hitches, and roof racks.

In cost-sensitive applications such as automobiles, conventional engineering materials force trade-offs between cost, fuel efficiency, safety, and performance. It is preferred that automotive structural members be lightweight to provide improved fuel economy, but of a sufficient strength and durability to meet automotive safety requirements. In addition, automotive structural members must be able to contend with harsh environmental conditions, and thus must be corrosion resistant.

Furthermore, many structural member must be fabricated by affixing structural components together such as by the use of mechanical fasteners or welding. Unfortunately, mechanical fasteners often add unwanted weight and cost. Meanwhile, the implementation of welding can alter and deteriorate the mechanical properties of the base metal.

As a result of the above constraints, present day automotive structural members are still undesirably heavy and expensive though ongoing attempts are being made to overcome these problems. For example, the automotive industry has recently introduced new alloys into automotive structures to improve hardness in an effort to reduce weight by reducing material. Furthermore, complicated and expensive coatings and heat treatments have been introduced to improve the characteristics of corrosion resistance, hardness, tensile strength, and toughness. Examples include efforts presented in U.S. Patent Application No. 2006/0130940 which describes a nickel coating process for automotive components, and U.S. Pat. No. 6,475,307 which describes a method of manufacturing automotive components of stainless maraging steel. Several attempts have also been made to selectively harden only portions of automotive structural members, such as described in U.S. Pat. No. 5,868,456 and U.S. Patent Application No. 2003/0025341.

Unfortunately, all of the aforementioned attempts at manufacturing structural automotive components suffer from various drawbacks. For example, prior manufacturing processes are either too expensive or produce automotive structural members having characteristics which are less than desirable such as a lack of hardness, durability, corrosion resistance, etc. As graphically depicted in FIG. 1, structural materials are currently available in a broad range of strength-to-weight ratios, or specific strengths, but the costs of these materials generally increase disproportionately to their specific strengths. Carbon composites and titanium, for example, while being perhaps ten times stronger than mild steel for a given weight, are typically more than fifty times more expensive when used to bear a given load. Consequently, such high performance materials are typically used only in small items or in applications where the high cost is justified, such as in aircraft.

Conventionally, automotive structural members are manufactured from non-air hardenable steels. A rare exception of this is boron-treated steel which provides high strength but it is not particularly corrosion resistant. Furthermore, the use of boron steel for automotive structural members typically requires implementing unwanted and expensive manufacturing steps to remove scale resulting from the hot-stamping hardening process.

An example of a non-air hardenable steel currently used in manufacturing is 4130steel (UNS G10220). This steel does not crack when formed. However, it must be liquid-quenched after heat-treating to attain a high strength, and unfortunately this liquid quenching tends to induce high levels of distortion. As a result, liquid quenched materials like 4130 have limitations when used for applications requiring frame-type structures that must be straight and free from distortion. Theoretically, the highest strength-to-weight ratio would be attained if parts of 4130 steel could be assembled together and then heated and liquid quenched as a whole, resulting in a frame with uniformly high-strength throughout all areas. However, liquid quenching an entire frame or large automotive structural component at one time would distort it beyond acceptable limits.

An example of a partially air hardenable steel is 410S (UNS S41008), made available by Allegheny Ludlum of Pittsburgh, Pa. 410S is a low carbon modification of 410 (UNS S41000). The low carbon level (0.08% maximum) of 410S prevents austenite formation upon heating, thereby preventing martensite formation upon cooling. This means that the metal doesn't crack during typical forming processes, but it also doesn't harden to a high strength condition. Automotive structural members comprised of 410S would lack the strength needed for load bearing applications.

Additional examples of partially air hardenable steel are True Temper OX Gold and Platinum series, produced by True Temper Sports, Inc. These non-stainless steels achieve high strength without cracking due to the precise addition of expensive alloying components. These alloy steels are specially formulated to mitigate the difficulties inherent in the welding of air hardenable steel. Unfortunately, the materials are too expensive to justify for most structural applications.

As reflected in FIG. 2, air hardenable martensitic stainless steels have exceptional strength, particularly compared to common metals such as aluminum and even titanium. Nevertheless, even though such steels are relatively affordable as illustrated in FIG. 1, experimentation with air hardenable stainless steel for automotive structural applications appears to have never been attempted due to the previously insurmountable problem of cracking. After typical automotive manufacturing forming processes, the structural component would have become hard and brittle and would crack during use as a load bearing structural member. Instead, air hardenable stainless steels have been mainly used in applications that do not require forming processes that would make the part susceptible to cracking.

Common air hardenable steels include martensitic stainless steels. As defined herein, and as understood by those skilled in the art, air hardenable martensitic stainless steels are essentially steel alloys of chromium and carbon that possess a body-centered-cubic (bcc) or body-centered-tetragonal (bct) crystal (martensitic) structure in the hardened condition. They are ferromagnetic and hardenable by heat treatment, and they are generally mildly corrosion resistant.

Air hardenable martensitic stainless steels include a relatively high carbon and chromium content compared to other stainless steels with a carbon content between 0.08% by weight and 0.75% by weight, and a chromium content between 11.5% by weight and 18% by weight. As reflected in FIG. 3, air hardenable martensitic stainless steels have also been defined, and are understood by those skilled in the art, as having a nickel equivalent of between about 4 and 12 and having a chromium equivalent of between about 8 and 15.5, where nickel equivalent is equal to (% Ni+30×% C)+(0.5×% Mn) and chromium equivalent is equal to (% Cr+% Mo+(1.5×% Si)+(0.5×% Nb). Either or both of these definitions are acceptable for practicing the present invention. According to these standard definitions, standard air hardenable martensitic stainless steels include types 403, 410, 414, 416, 416Se, 420, 420F, 422, 431, and 440A-C.

The relatively high carbon and chromium content compared to other stainless steels results in steel with good corrosion resistance, due to the protective chromium oxide layer that forms on the surface, and the ability to harden via heat treatment to a high strength condition. Unfortunately, the high carbon and chromium also presents difficulties related to brittleness and cracking, and accordingly martensitic stainless steel has been primarily used for cutting tools, surgical instruments, valve seats, and shears. Non-stainless air hardenable steels, which contain very high levels of carbon to allow the formation of a martensitic microstructure upon quenching, and are much more expensive than stainless types, also present difficulties related to brittleness and cracking.

The use of air hardenable martensitic stainless steels for golf clubs and bicycle applications was introduced in U.S. Pat. No. 5,485,948 and further described in U.S. Pat. No. 5,871,140. These patents describe brazed tube structures that take advantage of the fact that air hardenable stainless steel can be simultaneously brazed and hardened in one heat treating operation. However, there is no suggestion as to how to use such a material for larger load bearing structural members.

This ongoing lack of a strong and lightweight yet low cost automotive structural material is a main hindrance to the development of economically viable low emissions vehicles that can compare in performance, safety, comfort, and price to those powered by the typical internal combustion power system.

Thus, rather than resort to the use of expensive alloys, it would be beneficial to create a process that could utilize common, inexpensive, air hardenable steel to produce automotive structural members substantially free of cracks. Such a process would be even more beneficial if the material possessed the corrosion resistant properties of stainless steel.

Furthermore, it would be desirable for an improved method for manufacturing automotive structural members which are built strong and lightweight, yet are produced at low costs.

It would also be desirable to have an improved method of combining structural components to form structural members for load bearing applications including within planes, trains, bridges, and building reinforcements, as well as within automobiles and trucks.

### SUMMARY OF THE INVENTION

The present invention is directed to a method of manufacturing multi-component load bearing structural members for use within planes, trains, boats, bridges, building reinforcements, automobiles and trucks. Since the present invention is thought to have particular usefulness within automotive vehicles, the invention is described herein with particularity for manufacturing automotive structural members such as pillars, sub-frames, cross beams, frame rails, frame brackets, roof rails, seat frames, door beams, bumper beams, control arms, wheels, instrument panel reinforcements, running boards, roll-bars, tow hooks, bumper hitches, and roof racks using air-hardenable martensitic stainless steel. Preferred air-hardenable martensitic stainless steels include types 410, 420 and 440.

In accordance with the invention, the method of manufacturing a multi-component structural member includes providing first and second metal components. The first component is made from a blank of air hardenable martensitic stainless steel in the annealed condition having a thickness of 0.5 mm or greater. Preferably, the martensitic stainless steel blank is provided in a coil, strip or sheet form having a thickness of 0.5-5.0 mm. When the method of manufacturing a multi-component structural member is for use in fabricating an automotive part, it is preferred that the first component be an air hardenable martensitic stainless steel blank having a thickness of 0.5-3.0 mm. Importantly, the first component is provided in the annealed condition prepared in accordance with annealing processes known to those skilled in the art.

Meanwhile, it is preferred that the second metallic component also be made from a blank of an air hardenable martensitic stainless steel. However, in accordance with the present invention, the second component may be made of other ferrous, stainless or nickel alloy steels. Again, the second component has a thickness of between 0.5 mm and 5.0 mm, and for fabricating an automotive structural member preferably has a thickness of 0.5-3.0 mm. Preferably, the second component is also an air hardenable martensitic stainless steel such as type 410, 420 or 440. If the second component is an air hardenable martensitic stainless steel, it is preferably provided in the annealed condition.

The first component made of air hardenable martensitic stainless steel is formed into a structural member using any of a variety of traditional forming processes including stamping, forging, pressing, cold drawing, roll forming, etc. Meanwhile, the second component may also be formed into a structural member. However, because the second component may be made of materials other than air hardenable martensitic stainless steel, in non-preferred embodiments the second component may also be prepared by other manufacturing processes such as machining or casting.

Subsequent to forming the first and second components into the desired shapes, the components are prepared for joining. To this end, the first and second structural components are positioned adjacent to one another using fixtures or jigs as can be prepared by those skilled in the art. The first and second structural components are then brazed together.

Of importance, the brazing compound must be selected so as to braze within the same temperature range as for heat treating air hardenable martensitic stainless steel. Traditional air hardenable martensitic stainless steels including types 410, 420 and 440 are hardened by heat treatment between 950° C. and 1100° C. Thus, it is preferred that brazing be conducted between 950° C. and 1100° C. Moreover, it is anticipated that not-yet-developed air hardenable martensitic stainless steels may be heat treated at a broader range of temperatures such as 925° C. and 1200° C. Accordingly, it is an object of the invention that such alloys be brazed within a corresponding temperature range. Acceptable brazing compounds include copper based compounds such as common copper, copper-copper (also know as copper-cupric oxide), and copper-tin brazing pastes. Furthermore, brazing compounds designated CDA (Copper Development Association) 102 and CDA 110 are acceptable.

The brazing compound is deposited between the first and second structural components using automatic or manual applicators. Heat is applied, such as within a furnace or by application of heat by induction coils, to heat the first and second components and brazing compound to braze the components together. Importantly, heat is applied to the first and second component at temperatures between 925° C. and 1200° C., and preferably between 950° C. and 1100° C. for traditional air hardenable martensitic stainless steels.

Once heated to 925° C. and 1200° C., and preferably to between 950° C. and 1100° C., the (now) multi-component structural member is air cooled to complete the brazing process while simultaneously hardening at least the first structural component. Since the second component can be made of ferrous, stainless or nickel alloy steels other than martensitic stainless steel, such as mild steel, carbon steel, other stainless steels, the application of air cooling of the second component will not necessarily harden the second component. In fact, the second component, as in the case for austenitic grades of stainless steel, may become annealed or normalized. However, it is preferred that the second structural component also be formed of an air hardenable martensitic stainless steel blank so as to also harden during the heating/brazing/air cooling process.

For traditional air hardenable martensitic stainless steels including types 410, 420 and 440, the multi-component structural member must be air quenched at a rate of 25° C./minute or greater to obtain a fully hardened condition. Moreover, it is anticipated that air hardenable martensitic stainless steels may be developed which have improved chemistry which will allow the martensitic stainless steel to harden at a slower rate, such as 15° C./minute or greater. Advantageously, the application of heat will cause the air hardenable martensitic stainless steel to harden to a Rockwell C hardness of 39 or greater. For example, a first structural component made of type 410 martensitic stainless steel heated sufficiently during the brazing process will fully harden to a Rockwell C hardness of 40-44 and have a corresponding ultimate tensile strength of 1200-1500 Mega Pascals (“MPa”).

The joining of the first and second components provides a multi-component structural member, which is particularly useful for automotive applications including for use as vehicle pillars, sub-frames, cross beams, frame rails, frame brackets, roof rails, seat frames, door beams, bumper beams, control arms, wheels, instrument panel reinforcements, running boards, roll-bars, tow hooks, bumper hitches, and roof racks. After air quenching, the automotive structural members may be employed in a vehicle without further heat treatment where high strength is desired but limited ductility and brittleness are not concerns. However, in a preferred embodiment of the invention, the multi-component structural members are tempered after hardening. During a high temperature tempering process the multi-component structural member is heated to between 150° C. and 650° C. and allowed to air cool. This high temperature tempering provides substantial improvement in ductility and brittleness reduction without a substantial loss of hardness or strength. Alternatively, a low temperature tempering process may be conducted in which the multi-component structural member is heated between 130° C. and 180° C. Again, the low temperature tempering increases toughness and ductility without a substantial loss of hardness or strength. The low temperature tempering may also be conducted during an electro-coating process to provide additional corrosion resistance.

Advantageously, the multi-component structural members of the present invention have high strength, desirable toughness and ductility, and substantial corrosion resistance. Moreover, since air hardenable martensitic stainless steels are relatively inexpensive compared to many other alloys and composite materials, the present invention provides structural members having improved functional properties at a reduced cost.

It is thus an object of the present invention to provide a high strength, low cost process for manufacturing multi-component structural members for a wide variety of applications including within planes, trains, bridges, building reinforcements, etc. It is still an additional object of the present invention to provide a high strength, low cost process for manufacturing automotive multi-component structural members.

Other features and advantages will be appreciated by those skilled in the art upon reading the detailed description which follows with reference to the attached drawings.

### BRIEF DESCRIPTION OF THE DRAWINGS

FIG. 1 is a chart illustrating relative strength/cost advantages of various materials;

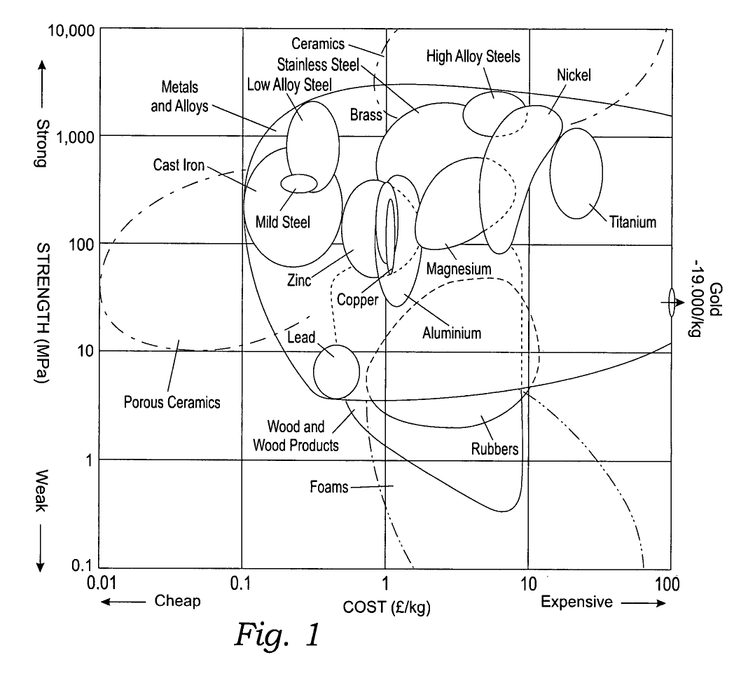

FIG. 2 is a chart illustrating relative strengths of various materials including martensitic stainless steel;

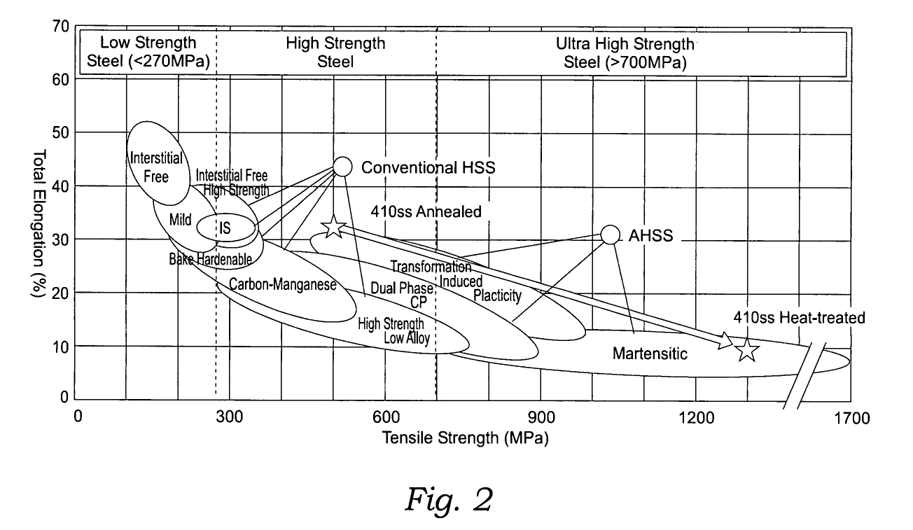

FIG. 3 is a chart illustrating a definition for martensitic stainless steel in terms of chromium equivalent and nickel equivalent;

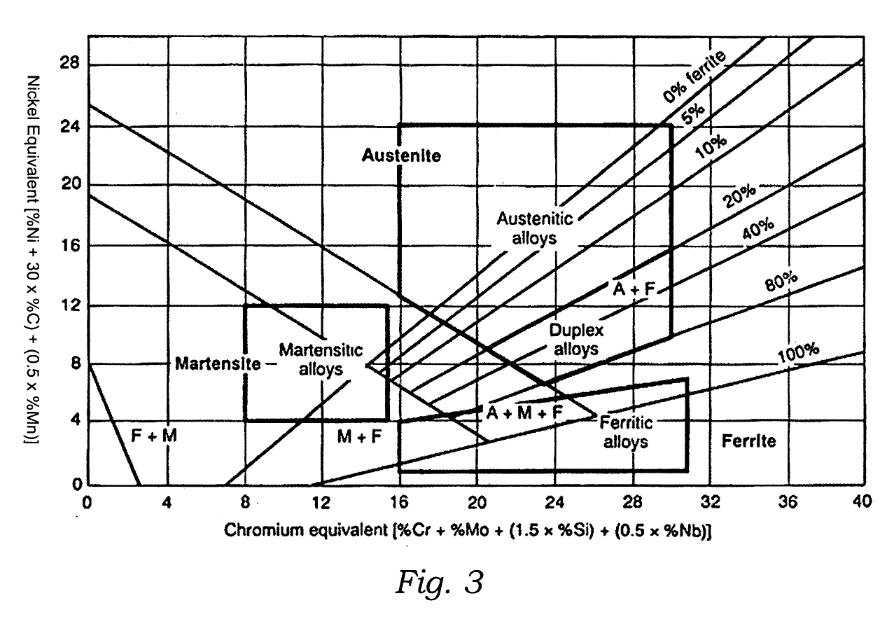

FIG. 4 is a flow chart illustrating the manufacturing process of the present invention for producing multi-component structural members;

FIG. 5 is an additional flow chart illustrating the manufacturing process of the present invention for producing multi-component structural members; and

FIG. 6 is a perspective view illustrating a multi-component structural member of the present invention in the form of an automotive bumper beam.

### DETAILED DESCRIPTION OF THE INVENTION

While the present invention is susceptible of embodiment in its various forms, there is shown in the drawings and will be hereinafter be described the presently preferred embodiments of the invention with the understanding that the present disclosure is to be considered as exemplifications of the invention and it is not intended to limit the invention to the specific embodiments illustrated.

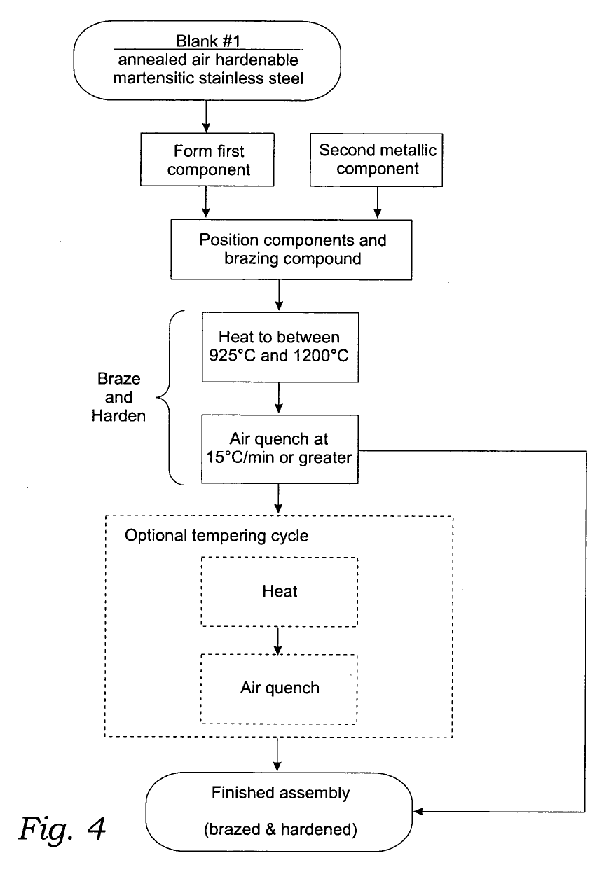

As illustrated in FIGS. 4-6, the present invention is directed to a method of manufacturing multi-component structural members for load bearing applications. Because automobiles and trucks employ a variety of high strength members which are fabricated from a plurality of components joined together, the manufacturing process of the present invention is believed to have particular suitability for fabricating automotive structural members for automobiles and trucks.

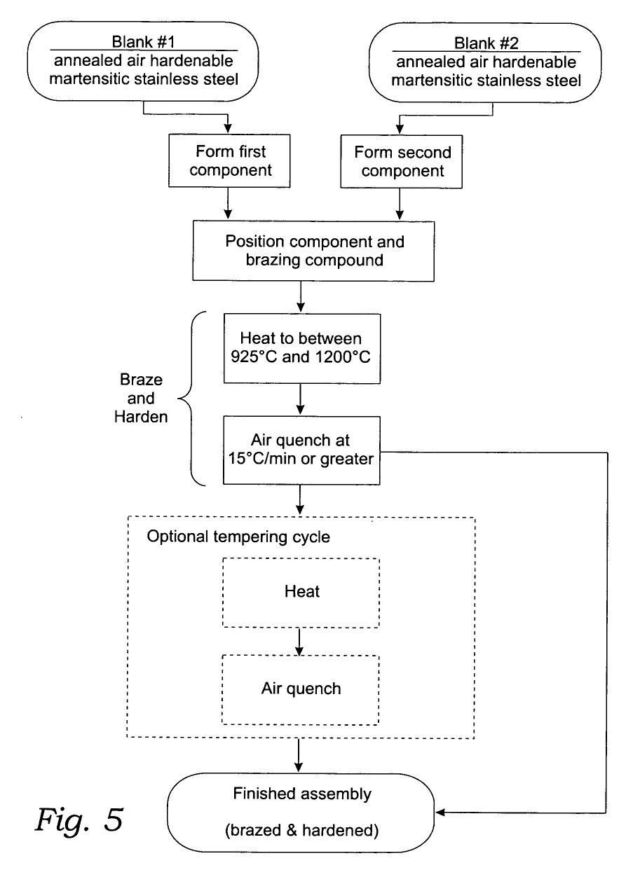

With reference to FIGS. 4 and 5, the method of manufacturing the multi-component structural member includes providing at least two components, designated herein as a first structural component and a second structural component. At least one of these structural components is formed from a blank of air-hardenable martensitic stainless steel. The blank is provided in the annealed state, preferably in a coil, strip or sheet form having a thickness of 0.5-5.0 mm. For automotive structural members, it is preferred that the blank be made of an air-hardenable martensitic stainless steel having a thickness of 0.5-3.0 mm. The blank is annealed, or provided in the annealed form, so as to have a microstructure consisting primarily of ferrite and chromium carbide compounds. Annealing of the martensitic stainless steel results in a reduced hardness, reduced yield and tensile strengths, and increased ductility. For example, annealing type 410 martensitic stainless steel typically produces blanks having a Rockwell B hardness of 82, an elongation of 34%, a 0.2% yield strength of 290 mega pascals (MPa), and a tensile strength of 510 MPa.

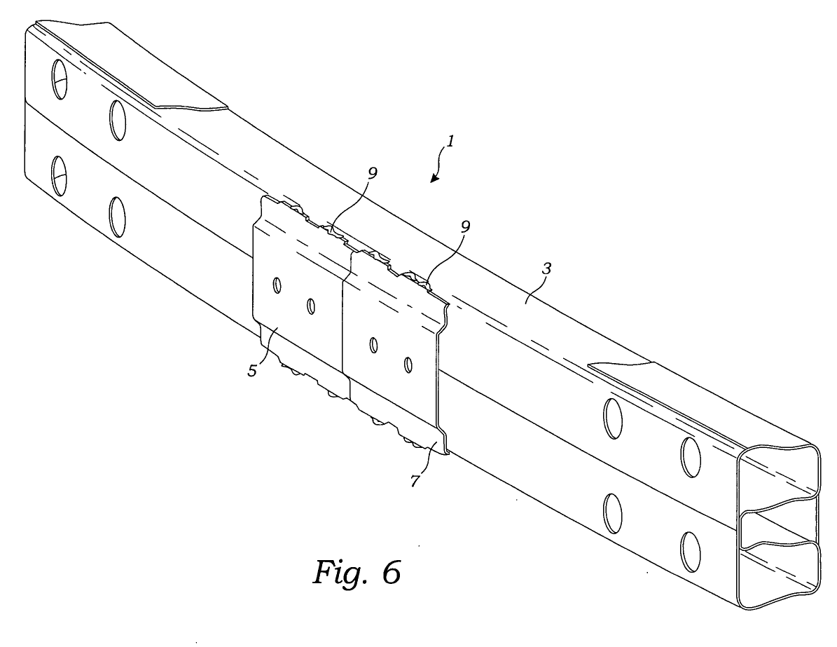

After being annealed, the air hardenable martensitic stainless steel blank is formed by conventional metal forming techniques including stamping, pressing, forging, cold drawing, roller forming, etc. to form a variety of structural components. As shown in FIG. 6, the present invention is particularly suitable for forming components of automotive structural members including bumper beams 3 and brackets 5, as well as pillars, sub frames, cross beams, frame rails, frame brackets, roof rails, seat frames, door beams, bumper beams, control arms, wheels, and instrument panel reinforcements. In addition, the first component may form part of an after-market automotive structural member such as a running board, roll bar, tow hook, bumper hitch or roof rack.

As shown in FIG. 4, the method of preparing a multi-component structural member of the present invention further includes providing a second structural component made of ferrous, stainless or nickel alloy steel. The second structural component can be fabricated using a variety of manufacturing processes including the forming processes described above, as well as by machining, casting, etc. However, it is preferred that the second structural component be formed of an air-hardenable martensitic stainless steel by conventional forming process including stamping, forging, pressing, cold drawing, roller forming, etc. to the shape of the structural member required. If the second structural component is made of an air-hardenable martensitic stainless steel, it is formed while in the annealed condition.

With reference to FIGS. 4 and 5, the first and second structural components are positioned within an assembly fixture so as to maintain them in proper orientation for joining. Fabrication of such fixtures can be done by those skilled in the art. Once positioned within the fixture, the first and second structural components are brazed together in a process which simultaneously hardens the annealed air-hardenable martensitic stainless steel.

The brazing compound is selected so as to braze at a temperature for heat treating the air-hardenable martensitic stainless steel. For example, where the first and second structural components are type 410 martensitic stainless steel, the brazing compound should be selected so as to braze between a temperature range of 950° C. and 1100° C. Acceptable brazing compounds include copper based compounds such as common copper, copper-copper, and copper-tin brazing pastes including those designated as CDA 102 and CDA 110.

The brazing paste is positioned so as to be drawn into the joint during the heating process. Heat is applied to the first and second components at temperatures between 925° C. and 1200° C., and preferably between 950° C. and 1100° C. where one or both of the structural components are made from a traditional air-hardenable martensitic stainless steel such as a type 410, 420 or 440. The structural components and brazing compound may be heated using a variety of known heat sources. Ideally, the structural components and brazing compound are heated using high throughput continuous furnaces producing heat through gas, electric or induction heating apparatus. The furnaces preferably employ a roller hearth or continuous mesh belt and may introduce a protective atmosphere of nitrogen, argon, hydrogen or disassociated ammonia to prevent oxidation of the structural components. During heating, the entire part should be heated to slightly above the martensitic stainless steel's upper critical temperature, which for type 410 type martensitic stainless steel is between 950° C. and 1100° C. Prior to heating of the first and second structural components, the brazing compound is applied to the joint with automatic or manual applicators.

Once the structural components and brazing compound have been heated to slightly above the steel's upper critical temperature, the entire structural member is air quenched so as to transform the steel into a predominantly martensitic microstructure. As defined herein, the terms “air cooling” and “air quenching” are intended to be interpreted broadly so as to include the implementation of protective atmospheres including nitrogen, argon, disassociated ammonia, or even a lack of an oxidizing atmosphere such as in a vacuum furnace, but to not include liquid quenching. The cooling zone preferably includes water jackets to remove excess heat while the protective atmospheric gas circulates in the chamber to cool the now multi-component structural member. Ideally, the air quenching is conducted sufficiently quickly so as to transform the air-hardenable martensitic stainless steel into a 90-100% martensitic microstructure and a 0-10% ferritic microstructure. For standard air-hardenable stainless steel's such as 410, 420 and 440, preferably the air-cooling process is conducted at a rate of 25° C. per minute or greater. In addition, it is anticipated that once the advantages of the present invention have been realized, that additional air-hardenable martensitic stainless steel's may be developed including additional alloys which allow the martensitic stainless steel to cool at a slower rate while still hardening. It is anticipated that such steels may be cooled at a rate of 15° C. per minute or greater.

As illustrated in FIGS. 4 and 5, the hardened structural member may be utilized without further heat treatment where high strength is desired and limited ductility and brittleness are not concerns. However, for most applications, it is preferred that the multi-component structural member be tempered. The multi-component structural member may be tempered through a high temperature tempering process or a low temperature tempering process. For high temperature tempering, the multi-component structural member is heated to between 150° C. and 650° C. Meanwhile, for low temperature tempering, the multi-component structural member would be heated to between 130° C. and 180° C. The low temperature tempering process may be conducted simultaneously during an electro-coating process during which the multi-component structural member would be heated to between 130° C. and 180° C. for 20-30 minutes. Once heated, the multi-component structural members is again air quenched which results in a structural member having reduced brittleness and corresponding increases in toughness and ductility as a result of the tempering process. Advantageously, tempering will not result in a substantial loss in hardness or strength.

The method of fabricating structural members of the present invention is believed to have particular application within the automotive industry where high strength and lightweight components are desirable. For example, as illustrated in FIG. 6, a bumper assembly 1 can be fabricated in accordance with the present invention. To this end, the first structural member 3 in the form of a bumper beam is prepared from a blank of annealed air-hardenable martensitic stainless steel. As an example, the blank is a sheet of 0.8 mm thick annealed type 410 martensitic stainless steel. The sheet is then roll formed into an elongate beam having several bends and punched to include lightening and fastening holes.

Meanwhile, the second component 5, and for this example a third component 7, in the form of brackets are also prepared from blanks of type 410 air-hardenable martensitic stainless steel. The blanks of preferably prepared from 1.5 mm thick sheets of annealed martensitic stainless steel. The blanks are then stamped to form the bracket's shape and punched to include central holes.

The first component beam 3, second component bracket 5, and third component bracket 7 may be placed within a fixture (not shown) so as to position the brackets against the bumper beam. All three components are processed through a continuous furnace, preferably employing a protective atmosphere. Prior to entering the furnace, brazing applicators deposit brazing compounds between the brackets and beam to form joints 9. During the brazing process, all three components and brazing compound are heated to between 950° C. and 1100° C. Thereafter, the now multi-component structural member 1 is removed from the heating section of the furnace and air quenched at a rate of 25° C. per minute or greater so that the steel is transformed into a 90-100% martensitic microstructure. After air quenching, the bumper assembly of type 410 martensitic stainless steel is in a fully hardened condition having a Rockwell C hardness of 40-44 and a corresponding tensile strength of 1200-1500 MPa.

Preferably, the bumper assembly 1 proceeds through an electro-coating process. During the electro-coating process the bumper assembly is simultaneously tempered by heating the multi-component structural member to between 130° C. and 180° C. for 20-30 minutes. Subsequent to the electro-coating process, the bumper beam is air quenched.

While several particular forms of the invention have been illustrated and described, it will be apparent to those skilled in the art that various modifications can be made without departing from the spirit and scope of the invention. Accordingly, it is not intended that the invention be limited except by the following claims.

We claim:

1. A method of manufacturing a multi-component structural part comprising the: steps of:
providing a first air hardenable martensitic stainless steel blank in the annealed condition having a thickness of 0.5 millimeters or greater;
forming the first steel blank while in an annealed condition into a first structural component;
providing a second structural component which is made of a ferrous steel, stainless steel or nickel steel alloy;
positioning the first component adjacent to the second component;
depositing a brazing compound between the first component and the second component;
brazing the first component and the second component together while simultaneously hardening at least the first component to a Rockwell C hardness of 39 or greater by heating the first component and the second component to between to between 925° C. and 1200° C. and subsequently air cooling the automotive structural member at a rate of 15° C./minute or greater.

2. The method of manufacturing a multi-component structural part of claim 1 further comprises the steps of:
providing a second air hardenable martensitic stainless steel blank in the annealed condition having a thickness of 0.5 millimeters or greater;
forming the second steel blank while in an annealed condition to form the second structural component; and
the step of applying heat to the first and second components simultaneously hardens the first component and the second component to a Rockwell C hardness of 39 or greater.

3. The method of manufacturing a multi-component structural part of claim 2 wherein the first and second components are made of martensitic stainless steel type 410 or type 420.

4. The method of manufacturing a multi-component structural part of claim 1 wherein the multi-component structural member is a vehicle structural member.

5. The method of manufacturing a multi-component structural part of claim 3 wherein the multi-component structural member is a vehicle structural member.

6. The method of manufacturing a multi-component structural part of claim 1 wherein the multi-component structural member is a vehicle pillar, sub-frame, cross beam, frame rail, frame bracket, roof-rail, seat frame, door beam, bumper beam, control arm, wheel, instrument panel reinforcement, running boards, roll-bar, tow hook, bumper hitch, or roof rack.

7. The method of manufacturing a multi-component structural part of claim 1 wherein the multi-component structural member is heated to between 950° C. and 1100° C. and subsequently air cooled at a rate of 25° C./minute or greater.

8. The method of manufacturing a multi-component structural part of claim 7 wherein the second component is made of air hardenable martensitic stainless steel and the step of applying heat to the first and second components simultaneously hardens the first component and the second component to a Rockwell C hardness of 39 or greater.

9. The method of manufacturing a multi-component structural part of claim 8 wherein the first and second components are made of martensitic stainless steel type 410 or type 420.

10. The method of manufacturing a multi-component structural part of claim 7 wherein the multi-component structural member is a vehicle structural member.

11. The method of manufacturing a multi-component structural part of claim 7 wherein the multi-component structural member is a vehicle pillar, sub-frame, cross beam, frame rail, frame bracket, roof-rail, seat frame, door beam, bumper beam, control arm, wheel, instrument panel reinforcement, running boards, roll-bar, tow hook, bumper hitch, or roof rack.

12. The method of manufacturing a multi-component structural part of claim 9 wherein the multi-component structural member is a vehicle pillar, sub-frame, cross beam, frame rail, frame bracket, roof-rail, seat frame, door beam, bumper beam, control arm, wheel, instrument panel reinforcement, running boards, roll-bar, tow hook, bumper hitch, or roof rack.

13. A method of manufacturing a multi-component structural part comprising the steps of:
providing a first air hardenable martensitic stainless steel blank in the annealed condition having a thickness of 0.5 millimeters or greater;
forming the first steel blank while in an annealed condition into a first structural component;
providing a second structural component which is made of a ferrous steel, stainless steel or nickel steel alloy;
positioning the first component adjacent to the second component;
depositing a brazing compound between the first component and the second component;
brazing the first component and the second component together while simultaneously hardening at least the first component to a Rockwell C hardness of 39 or greater by heating the first component and the second component to between to between 950° C. and 1100° C. and subsequently air cooling the automotive structural member at a rate of 25° C./minute or greater.

14. The method of manufacturing a multi-component structural part of claim 13 further comprises the steps of:
providing a second air hardenable martensitic stainless steel blank in the annealed condition having a thickness of 0.5 millimeters or greater;
forming the second steel blank while in an annealed condition to form the second structural component; and
the step of applying heat to the first and second components simultaneously hardens the first component and the second component to a Rockwell C hardness of 39 or greater.

15. The method of manufacturing a multi-component structural part of claim 14 wherein the first and second components are made of martensitic stainless steel type 410 or type 420.

16. The method of manufacturing a multi-component structural part of claim 13 wherein the multi-component structural member is a vehicle structural member.

17. The method of manufacturing a multi-component structural part of claim 15 wherein the multi-component structural member is a vehicle structural member.

18. The method of manufacturing a multi-component structural part of claim 16 wherein the multi-component structural member is a vehicle pillar, sub-frame, cross beam, frame rail, frame bracket, roof-rail, seat frame, door beam, bumper beam, control arm, wheel, instrument panel reinforcement, running boards, roll-bar, tow hook, bumper hitch, or roof rack.

19. The method of manufacturing a multi-component structural part of claim 17 wherein the multi-component structural member is a vehicle pillar, sub-frame, cross beam, frame rail, frame bracket, roof-rail, seat frame, door beam, bumper beam, control arm, wheel, instrument panel reinforcement, running boards, roll-bar, tow hook, bumper hitch, or roof rack.

20. The method of manufacturing a multi-component structural part of claim 17 wherein the brazing compound is a copper based brazing compound.
